(19) United States
(12) Patent Application Publication
(10) Pub. No.: US 2002/0005625 A1
(43) Pub. Date: Jan. 17, 2002

(54) Multi-purpose trailer

(76) Inventor: John M. Palmer, Cicero, NY (US)

Correspondence Address: HANCOCK & ESTABROOK, LLP, 1500 MONY Tower I, PO Box 4976, Syracuse, NY, 13221-4976, US

(21) Appl. No.: 09/902,191

(22) Filed: Jul. 10, 2001

Related U.S. Application Data
(60) Provisional application No. 60/218,211, filed on Jul. 14, 2000.

(51) Int. Cl. B60D 1/00

(52) U.S. Cl. 280/477; 280/504

(57) ABSTRACT

The present invention provides a base trailer to which various types of cargo support platforms may be attached. The base trailer includes a rear axle with wheels rotatably supported on its opposing ends, and a main beam (or neep) extending forwardly from the center of the axle and including a conventional tow hitch attached to its forward end. A traditional suspension system, such as leaf springs or a torsional system, may be incorporated into the axle and wheel structure. A pair of mounting brackets are attached to the axle, adjacent each of the wheels, and a mounting hole is formed through the main beam, at an intermediate point therealong.

### REFERENCE TO RELATED APPLICATION

The present application claims priority to Applicant's U.S. Provisional Application Serial No. 60/218,211, filed Jul. 14, 2000.

### BACKGROUND OF THE PRESENT INVENTION

The present invention relates generally to utility trailers, and more particularly to multi-purpose utility trailers.

The use of a trailer that may be towed behind a vehicle is a common item used to transport recreational vehicles, such as snowmobiles, boats, jet skis, campers, and the like.

These trailers generally include a fixed, cargo supporting platform attached to a wheeled chassis and on which the recreational vehicle (or other item) may be securely positioned while in transport. The trailers are generally designed to accommodate a certain type of cargo, such as a snowmobile, two snowmobiles, a boat, and the like. Thus, persons owning more than one type of “cargo” may need to own more than one trailer in order to transport the various items.

It is therefore a principal object and advantage of the present invention to provide a trailer that can accommodate multiple types of cargo.

It is another object and advantage of the present invention to provide a trailer having an adjustable width, thereby enabling it to carry multiple units if necessary.

It is a further object and advantage of the present invention to provide a trailer to which various types of cargo support platforms may be easily attached.

Other objects and advantages of the present invention will in part be obvious and in part appear hereinafter.

### SUMMARY OF THE INVENTION

In accordance with the foregoing objects and advantages, the present invention provides a base trailer to which various types of cargo support platforms may be attached. The base trailer includes a rear axle with wheels rotatably supported on its opposing ends, and a main beam (or neep) extending forwardly from the center of the axle and including a conventional tow hitch attached to its forward end. A traditional suspension system, such as leaf springs or a torsional system, may be incorporated into the axle and wheel structure. A pair of mounting brackets are attached to the axle, adjacent each of the wheels, and a mounting hole is formed through the main beam, at an intermediate point therealong.

A cargo support platform includes a base with a downwardly facing surface, and at least a pair of support joists attached to the downwardly facing surface, each one positioned adjacent opposing side edges of the platform. A mounting tab is attached to each of the two joists and a mounting plate is attached to the forward edge of the downwardly facing surface. These mounting tabs and mounting plate are positioned so as to engage the trailer's two mounting brackets and mounting hole, respectively, when the cargo support platform is placed on the trailer. Conventional fasteners may be used to securely interconnect the platform and trailer.

In an alternate embodiment, the trailer may include a telescoping main beam, so as to permit adjustment to its length, and a pair of axles that telescopically engage the opposing ends of an axle encapsulating structure, thereby permitting the width of the trailer to be selectively adjusted. The main beam includes a tubular member that extend forwardly from the encapsulating structure, and a beam member that telescopically engages the tubular member and includes a towing hitch on its forward end. The encapsulating structure is a hollow tube which receives the inner ends of the two axles in its opposing ends, while the outer ends of the axles include wheels rotatably mounted thereto. Conventional fasteners secure the beam and axles in position.

As another option, the present invention may include a device for supporting and storing a cargo support platform separate from the trailer. The supporting/storage device includes a pair of U-shaped stands each including an arm (one of which is adjustable) extending perpendicularly outwardly from the opposing legs of the stands, adjacent their free ends. In use, the trailer is parked at the location at which it is desired to store the platform, and the two support/storage devices are positioned on opposing sides of the platform. The supports are positioned on the ground with their legs extending vertically upwardly. The platform is lifted off the trailer via a jack or other conventional hoisting device. The arms of the two supports are then positioned in engaging relation to the underside of the platform. The trailer is then moved from beneath the platform to its new desired location and the storage device supports the platform at its storage location.

### BRIEF DESCRIPTION OF THE DRAWINGS

The present invention will be better understood and more fully appreciated by reading the following Detailed Description in conjunction with the accompanying drawings, in which:

FIG. 1 is a perspective view of a first embodiment of the trailer of the present invention;

FIG. 2 is a perspective view of a second embodiment of the trailer of the present invention;

FIG. 3 is a perspective view of a cargo support platform positioned in spaced relation to the trailer of FIG. 2;

FIG. 4 is a perspective view of the cargo support platform support/storage device; and

FIG. 5 is a fragmentary, perspective view of the mounting structure of the trailer and cargo support platform of the present invention.

### DETAILED DESCRIPTION

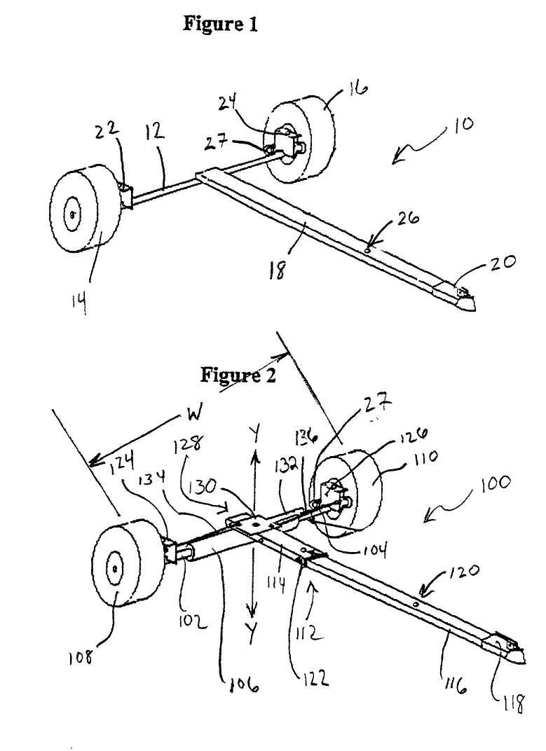

Referring now to the drawings, wherein like reference numerals refer to like parts throughout, there is seen in FIG. 1 a trailer designated generally by reference numeral 10. Trailer 10 generally includes an axle 12 having wheels 14, 16 rotatably attached to its opposing ends, a main beam 18 attached to and extending forwardly from the center of axle 12, a towing hitch 20 attached to the forward end of beam 18, a pair of brackets 22, 24 attached to axle 12 adjacent each wheel 14, 16, respectively, and a mounting hole 26 formed through beam 18 at an intermediate position therealong. A conventional suspension system 27, such as leaf springs (not shown) or a torsional type system (shown), may be incorporated into the wheel/axle structure.

With reference to FIG. 2, an alternate embodiment of the trailer of the present invention is illustrated. Trailer 100 generally includes a pair of axles 102, 104 that telescopically engage the opposing ends of an axle encapsulation member 106, and which include a pair of wheels 108, 110 rotatably connected thereto, respectively, and a beam assembly, designated generally by reference numeral 112. Beam assembly 112 includes a tubular member 114 attached to and extending forwardly from encapsulation member 106, and a beam member 116 telescopically engaged with and extending forwardly from tubular member 114. Beam member 116 includes a towing hitch 118 attached to its forward end, and a mounting hole 120 formed therethrough at an intermediate position therealong. A conventional fastener 122, such as a pin, interconnects tubular member 114 and beam member 116.

Trailer 100 further includes a pair of mounting brackets 124, 126 attached to axles 102, 104, respectively, and a width adjustment assembly, designated generally by reference numeral 128, of which axle encapsulation member 106 forms a part thereof. Width adjustment assembly 128 further includes a plate 130 mounted to the upper surface of tubular member 114 for rotation about its central, vertical axis Y-Y, an arm 132 extending outwardly from plate 130, and a pair of mechanical linkages 134, 136 extending between and interconnecting plate 130 (linkages 134, 136 are connected to diagonally opposite comers of plate 130) to mounting brackets 124, 126, respectively. A user may grasp arm 132 and rotate it either clockwise or counter-clockwise, thereby causing linkages 134, 136 to either decrease or increase the effective width W of trailer 100, respectively.

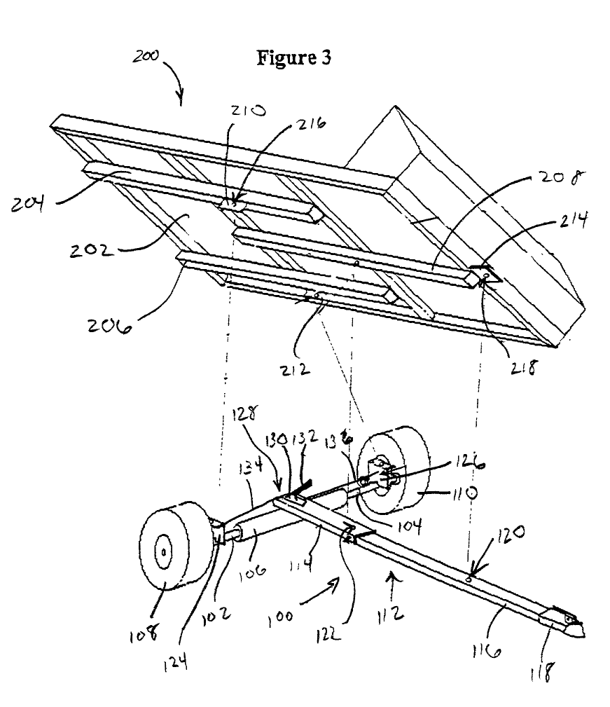

Referring to FIG. 3, a cargo support platform 200 may be interconnected to trailer 10 or 100. It should be noted that FIG. 3 illustrates platform 200 being connected to trailer 100, but it could also be attached to trailer 10 in the precise same manner. Platform 200 includes a bottom surface 202, a pair of joists 204, 206 attached to bottom surface 202 and extending parallel to the longitudinal axis of platform 200 adjacent opposing sides thereof, and a centrally extending joist 208 attached to bottom surface 202. Mounting tabs 210, 212 are attached to joists 204, 206, respectively, and a mounting plate 214 is attached to platform 200 adjacent the forward end of joist 208.

Referring to FIG. 5, to interconnect platform 200 to trailer 100 (or trailer 10), a user would position mounting tabs 210, 212 in engaging relation to mounting brackets 124, 126 (or mounting brackets 22, 24), respectively, and mounting plate 214 in overlying relation to mounting hole 120 (or mounting hole 26). Holes 216, 138 formed through mounting tab 210 (and 212) and mounting bracket 124 (and 126), respectively, should be axially aligned, while hole 218 formed through mounting plate 214 is axially aligned with hole 120 such that conventional fasteners, such as pins, may be used to securely interconnect platform 200 to trailer 100.

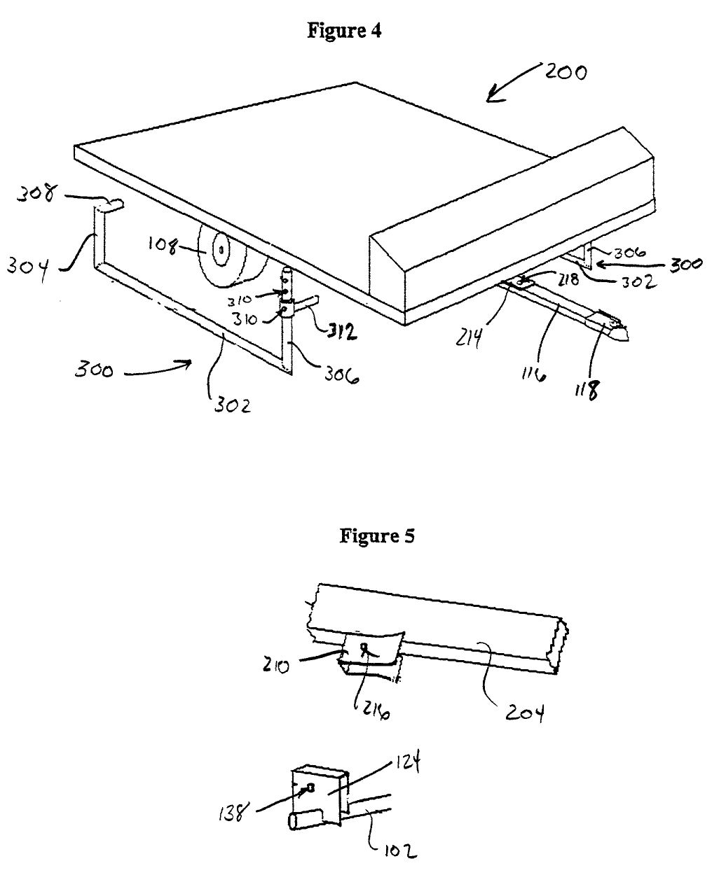

Referring to FIG. 4, a cargo platform support, designated generally by reference numeral 300, is illustrated (a pair of supports 300 are needed to support a cargo platform). Support 300 generally comprises a U-shaped body having a medial portion 302 and a pair of legs 304, 306 extending in parallel relation to one another and perpendicularly outwardly from opposing ends of medial portion 302. Leg 304 includes an arm 308 extending perpendicularly outwardly from its terminal, free end, and leg 306 includes a series of longitudinally spaced, axially aligned pairs of holes 310 formed therethrough adjacent its terminal, free end. An arm 312 is movably and securely interconnected to leg 306 via pin 314, extending in perpendicular relation to arm 306 and in parallel relation to arm 308.

Support 300 is used to hold cargo platform 200 (typically with cargo positioned thereon) in a stored location while giving the owner use of trailer 100 (or 10, for convenience only trailer 100 will be referred to hereinafter) to move other cargo platforms. To store a cargo platform 200, the user would move trailer 100 with platform 200 thereon to the desired storage location. A conventional jack, or other hoisting device, would then be positioned under the forward end of trailer 100 and used to raise it a predetermined distance off the ground. The user then positions a support 300 under each of the side edges of trailer 100 with medial portion 302 engaging the ground and legs 304, 306 extending vertically upwardly therefrom (this, and the following steps are done to each of the two supports 300). Arm 312 is then vertically adjusted, if necessary, to engage bottom surface 202 of platform 200. The jack, or other hoisting device, is then disengaged from platform 200, thereby leaving platform 200 resting on supports 300. Trailer 100 may then be moved either forward or rearward from beneath platform 200, and then used to carry another platform 200 (typically with a different form of cargo than the previously used trailer).

What is claimed is:

1. A multi-purpose trailer adapted for carrying a cargo platform thereon, comprising:
a. an elongated axle having first and second ends and first and second wheels rotatably connected to said first and second ends, respectively;
b. an elongated beam connected to and extending forwardly from said axle, and having a rear end, a forward end, and a hole formed therethrough at an intermediate position therealong; and
c. first and second mounting brackets interconnected to said axle and positioned adjacent said first and second wheels, respectively.

2. The multi-purpose trailer of claim 1, further comprising a tow hitch attached to said forward end of said beam.

3. The multi-purpose trailer of claim 1, wherein said beam is interconnected to said axle at its said rear end.

4. A multi-purpose trailer adapted for carrying a cargo platform thereon, comprising:
a. first and second axles each having first and second opposite ends;
b. first and second wheels rotatably connected to said first ends of said first and second axles, respectively;
c. a trailer width adjustment mechanism to which said second ends of said first and second axles are telescopically engaged; and
d. an elongated beam assembly connected to and extending forwardly from said width adjustment mechanism.

5. The multi-purpose trailer of claim 4, wherein said elongated beam includes a rear end, a forward end, and a hole formed therethrough at an intermediate position therealong.

6. The multi-purpose trailer of claim 5, wherein said beam is interconnected to said width adjustment mechanism at its said rear end.

7. The multi-purpose trailer of claim 5, further comprising a tow hitch connected to said forward end of said beam.

8. The multi-purpose trailer of claim 4, wherein said width adjustment mechanism comprises a hollow, tubular member.

9. The multi-purpose trailer of claim 8, further comprising first and second mounting brackets attached to said first and second axles, respectively.

10. The multi-purpose trailer of claim 9, wherein said width adjustment mechanism further comprises:
a. a plate mounted to said axle for rotation about its central axis;
b. a handle connected to said plate; and
c. first and second linkages interconnected between said plate and said first and second brackets, respectively.

11. The multi-purpose trailer of claim 4, wherein said elongated beam assembly comprises a single beam.

12. The multi-purpose trailer of claim 4, wherein said elongated beam assembly includes a tubular beam member attached to said width adjustment mechanism, and a beam member telescopically engaged with and extending forwardly from said tubular beam member.

13. A multi-purpose trailer adapted for carrying a cargo platform thereon, comprising:
a. first and second axles each having first and second opposite ends;
b. a width adjustment mechanism, comprising a hollow, tubular member having first and second opposite ends which telescopically receive said first and second axles, respectively; and
c. an elongated beam assembly connected to and extending forward from said tubular member.

14. The multi-purpose trailer of claim 13, wherein said width adjustment mechanism further comprises:
a. plate interconnected to said tubular member for rotation about its central axis;
b. a handle connected to said plate; and
c. first and second linkages interconnected between said plate and said first and second brackets, respectively.

15. The multi-purpose trailer of claim 13, wherein said elongated beam assembly comprises a single beam.

16. The multi-purpose trailer of claim 13, wherein said elongated beam assembly comprises a tubular beam member attached to said tubular member of said width adjustment mechanism, and a beam member telescopically engaged with and extending co-linearly from said tubular beam member.

17. A system for supporting a cargo platform having a bottom surface and first and second opposing side edges at a remote location, said system comprising first and second support members adapted for engagement with said bottom surface, adjacent said first and second side edges of said cargo platform , respectively, wherein each of said support members comprises:
a. a medial portion having first and second ends;
b. first and second legs each having free, terminal ends and extending perpendicularly outwardly from said first and second ends, respectively, and in parallel relation to one another; and
c. first and second arms attached to said first and second legs, respectively, and extending in parallel relation to one another.

18. The support system according to claim 16, wherein said first arm is rigidly attached to said free, terminal end of said first leg.

19. The support system according to claim 16, wherein said second arm is adjustably connected to said second leg.
